(19) United States
(12) Patent Application Publication
(10) Pub. No.: US 2003/0040436 A1
(43) Pub. Date: Feb. 27, 2003

(54) Use of benzyl ester compositions for controlling non-arthropod pest populations

(76) Inventors: Ralph W. Emerson, Davis, CA (US); Thomas C. Miller, Davis, CA (US)

Correspondence Address: BARBARA RAE-VENTER, RAE-VENTER LAW GROUP, P.C., PO BOX 60039, PALO ALTO, CA, 94306, US

(21) Appl. No.: 10/032,685

(22) Filed: Oct. 23, 2001

Related U.S. Application Data
(60) Provisional application No. 60/242,588, filed on Oct. 23, 2000.

(51) Int. Cl. A01N 59/00

(52) U.S. Cl. 504/150

(57) ABSTRACT

The invention is directed to methods and compositions for controlling a pest population using one or more carboxy ester compounds which comprise aromatic acids, aliphatic acids, and/or salicylate derivatives. The invention embodiments disclosed herein are intended for the control of pests such as plant pests and agricultural pests. These pest control methods are helpful in controlling pests by contacting pests with the carboxy ester compounds of the invention. The subject methods will reduce the detrimental environmental impact and health hazards of pest control by minimizing the toxicity of the subject compositions.

### CROSS-REFERENCE TO RELATED APPLICATIONS

This application claims priority of U.S. patent provisional application Serial No. 60/242,588 filed on Oct. 23, 2000, which disclosure is incorporated herein by reference.

### INTRODUCTION

### BACKGROUND OF THE INVENTION

Field of the Invention

The field of the invention is methods of control of pest populations such as protists, protist-like organisms and monera, using carboxy ester, formulations. The invention is exemplified by the use of benzoyl benzoate to inhibit growth of algae and moss.

Background

Protist pest organisms such as algae and watermolds, as well as many protists-like pest organisms (e.g., mosses), are detrimental to agriculturally important plants and animals. Such pests include pathogenic organisms which can infest animals and plants in both terrestrial and aquatic environments; some of these pests can produce toxins and can cause disease by acting as disease vectors. Disease-causing organisms which inhabit terrestrial and aquatic environments include both unicellular and simple-structure multicellular cukaryotic protists.

Methods for controlling such pest organisms in terrestrial environments include spraying plants, soil and surfaces with algicides and fungicides at times when environmental conditions favor pest development. These methods are typically used for controlling algae and protists-like infestation such as cyanobacterium, moss, liverwort and hornwort. The compounds used for controlling pest infestation include products such as sodium hypochlorite, copper sulfate anhydrons and mono (N,N-dimethylalkylamine) salt of endothall. In both aquatic and terrestrial environments such compounds have limitations because of their potential for polluting soil, air, and water, their strong physiological phytotoxic effects on plants, their residual toxicity, their high animal toxicity, and the potential hazards to workers using them. Many of these compositions are toxic and fatal to large animals, including man, in addition to being toxic and lethal to fish and other aquatic life. In addition, many of these compositions have been found to contaminate natural resources ranging from drinking water to the intricate ecosystems of lakes and ocean banks. Such problems have led federal and state government to ban or restrict the use of many pesticides, including DDT, Chlorodane, Lindane, Aldrin, Heptachlor, copper, Dieldrin, and Mirox. Other compositions which are still in use present varying degrees of unwanted toxicity. Besides unwanted toxicity, presently-known pesticides have other problems. They tend to be complex and expensive to produce. Moreover, it is often necessary to apply multiple pesticides or one pesticide multiple times to obtain satisfactory control of a variety of pests. For example, Daconil, a registered fungicide, has to be applied 4 to 5 times to control certain algae and cyanobacterium species on turfgrass.

Biorational pesticides also are used in controlling pathogenic and pest organisms. A method of induction of systemic resistance to powdery mildew in cucumber by phosphates has been described (see Reuveni et al (1993) Biol. Agric. & Hort. 9:305-315). The phosphate salts serve the dual purpose of acting as a foliar fertilizer and as an agent for inducing resistance to pathogenic organisms. However, excessive use of phosphates produces agricultural runoffs that can cause water pollution. Methods for controlling powdery mildew and black spot on roses have been described Plant Disease (1992) 76:247-251 which use sodium bicarbonate and light paraffinic petroleum oil. However, the bicarbonate salts are fungicidal only at pH 8.6 and are non-fungicidal at pH 6.0. The bicarbonate salts also can be phytotoxic as a function of environmental conditions at the time of treatment.

Also used for control of pathogens are anti-transpirants. Anti-transpirants are chemicals applied directly to a plant which reduce the rate of transpiration or water loss by the plant. Anti-transpirants form a film on a plant surface which acts as a barrier against invading pests. The anti-transpirant formulations are reported to have low mammalian toxicity. However, because the anti-transpirants control pests through the formation of a protective barrier, it is useful only as a means of prevention rather than as a treatment of an already infected host.

Given the limitations of available approaches to pest control, a need exists to identify compositions and methods for controlling the growth of pathogenic and pest organisms which are efficacious, specific for the pest target, less damaging to the environment. Optimally, such compositions and methods would be effective against more than one kind of pest such that the need for application of multiple pest control agents is diminished. Approaches to pest control which meet these stringent criteria have remained frustratingly elusive.

Description of Related Art

Examples of pesticides which comprise carboxy ester compounds include malathion (Johnson et al., (1952) J. Econ. Entomol. 45: 279) and fenvalerate (Fujimoto et al., (1972) Japanese patent no. 47-69805 and (1974) German patent no. 2,335,347). Both of these compounds are used as insecticides. Benzyl benzoate has been incorporated into scabacide and pediculicide formulations (Bhattacharya et. al., (1968) Bull Calcutta Sch Trop Med 16:18) and as an acaracide (Hart et. al. (1992) Clin. Exp. Allergy 22: 923) Methyl salicylate is able to repel ants (Shorey et. al. (1998) U.S. Pat. No. 5,849,317). Benzyl esters, including methyl salicylate and benzyl salicylate, have been shown to control fungi and arthropods (Emerson (1999) U.S. Pat. No. 6,124,275).

### SUMMARY OF THE INVENTION

The present invention is based, at least in part, on methods of controlling a pest population which comprise contacting the pest population with a composition which comprises a pesticidally effective amount of a carboxy ester compound. In one aspect, the composition also comprises one or more compounds chosen from the group consisting of a stabilizer, a surfactant, an active compound, and carrier. In another aspect, the pest population comprises pests other than arthropods, i.e., non-arthropods. In another aspect, the pest population comprises protists, protist-like organisms, water molds, or combinations thereof. In yet a further aspect of the present invention, the pest population comprises algae, cyanobacteria, moss, liverwort, hornwort, Phytopthora infestans, downy mildew, or combinations thereof. In another embodiment, the compositions of the invention are not toxic to non-targeted organisms.

The present invention is further based, at least in part, on methods for controlling a pest population which comprise contacting the pest population with a composition which comprises a pesticidally effective amount of a compound of formula (I):

A-L-E

wherein, A is an aryl group, L is a linkage group, and E is a terminal group. In another embodiment of the invention, group A comprises a carbocyclic moiety which may or may not be substituted. In further embodiments, group A is substituted, it is substituted with one or more hydroxyl, halogen, or carboxylic substituents. In yet a further embodiment, group A is substituted with a carboxylic substituent which is an ester. In other embodiments, group A may comprise a phenyl or an aralkyl or one or more benzyl moieties. In another embodiment, of the invention, group L has the formula

—(C═O)—B—

wherein B is oxygen, sulfur, or a covalent bond. In another related embodiment, group B may connect directly to either group A or group E. In a further aspect of the invention, group E comprises an alkyl moiety. In a related embodiment, group E is a lower alkyl including, but not limited to, butyl, propyl, ethyl, or methyl. In another embodiment, group E is comprises an aryl moiety which is carbocyclic or heteroaryl. In a further aspect, group E may be a phenyl moiety. In a related embodiment, group E may be an aralkyl moiety which may include a phenyl group or may be a benzyl group. In another embodiment, group E is a phenethyl group. In another embodiment, the composition which comprises Formula I further comprises stabilizer, surfactant, active compound, carrier, or a combination thereof. In another embodiment, the pest population which is controlled by compositions of Formula I comprises protists, protist-like organisms, water molds, or combinations thereof. In a related embodiment, the pest population which is controlled by compositions of Formula I comprises algae, cyanobacteria, moss, liverwort, hornwort, Phyopthora infestans, downy mildew or combinations thereof. In a further embodiment, compositions of the invention which comprise Formula I are not toxic to non-targeted organisms.

The present invention is further based, at least in part, on methods for controlling a pest population which comprise contacting the pest population with a composition which comprises a pesticidally effective amount of a compound of Formula II

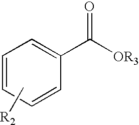

wherein R₂ may be H, OH, a halogen, an alkyl, an alkoxy, and R₃ is alkyl, aryl or arylalkyl. In a related embodiment, R₂ may a group with the formula —COOR₄, wherein R₄ may be alkyl or H. In yet a further related embodiment, R₂ contains 1 to 6 carbon atoms or is —COOR₄, wherein R₄ contains 1 to 6 carbon atoms. In another embodiment, R₃ is alkyl with one to six carbons, arylalkyl with one to six carbons, phenyl, or benzyl. In another embodiment, the composition which comprises Formula II further comprises stabilizer, surfactant, active compound, carrier, or a combination thereof. In another embodiment, the pest population which is controlled by compositions of Formula II comprises protists, protist-like organisms, water molds, or combinations thereof. In a related embodiment, the pest population which is controlled by compositions of Formula II comprises algae, cyanobacteria moss, liverwort, hornwort, Phytopthora infestans, downy mildew or combinations thereof. In a further embodiment, compositions of the invention which comprise Formula II are not toxic to non-targeted organisms.

The present invention is further based, at least in part, on methods for controlling a pest population which comprise contacting the pest population with a composition which comprises a pesticidally effective amount of a compound of Formula III

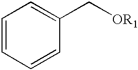

wherein R₁ is an alkylcarbonyl. In a preferred embodiment, contains one to five carbon atoms. In other preferred embodiment, R₁ is methyl carbonyl, H, —OH or —COO—(CH₂)₃CH₃, methyl, ethyl, benzyl or phenyl. In another embodiment, R₃ is alkyl with one to six carbons, arylalkyl with one to six carbons, phenyl, or benzyl. In another embodiment, the composition which comprises Formula III further comprises stabilizer, surfactant, active compound, carrier, or a combination thereof. In another embodiment, the pest population which is controlled by compositions of Formula III comprises protists, protist-like organisms, water molds, or combinations thereof. In a related embodiment, the pest population which is controlled by compositions of Formula III comprises algae, cyanobacteria, moss, liverwort, hornwort, Phytopthora infestans, downy mildew or combinations thereof. In a further embodiment, compositions of the invention which comprise Formula III are not toxic to non-targeted organisms.

The present invention is further based, at least in part, on methods for controlling a pest population, which method comprises contacting a pest population with a pesticidally effective amount of one or more compounds chosen from the group consisting of methyl salicylate, ethyl salicylate, benzyl salicylate, benzyl benzoate, phenethyl salicylate, phenyl salicylate, benzyl phthalate, benzyl butyl phthalate, and benzyl acetate. In another embodiment, this composition further comprises stabilizer, surfactant, active compound, carrier, or a combination thereof. In another embodiment, the pest population which is controlled by the compositions contains protists, protist-like organisms, water molds, or combinations thereof. In a related embodiment, the pest population which is controlled by these compositions includes algae, cyanobacteria, moss, liverwort, hornwort, Phytopthora infestans, downy mildew or combinations thereof. In a further embodiment, compositions of the invention which comprise these are not toxic to non-targeted organisms.

### DETAILED DESCRIPTION

I. Definitions

The present invention is based, at least in part, on methods of controlling a pest population involving contacting the pest population with a composition which comprises a pesticidally effective amount of a carboxy ester compound.

The term “carboxy ester compound” includes compounds which comprise a carboxy ester moiety. Compounds which contain a carboxy ester moiety include aromatic acid derivatives, aliphatic acid derivatives, and salicylate derivatives (e.g., preferred compounds of the invention include benzyl esters of aromatic acids, benzyl esters of aliphatic acids, and benzyl esters of salicylate derivatives).

As used herein the terms “pest,” and “pest organism,” includes organisms, microorganisms, and pathogens which are controlled by pesticidally effective amounts of a composition of the present invention (e.g., organisms, microorganisms, and pathogens which negatively affect the health or fecundity of non-target organisms). Pests may normally achieve these negative effects through a number of mechanism, including colonizing (e.g., infecting, infesting, residing upon, attaching to) a non-target organism. Pests may also achieve these effects by competing with a non-target organism for common essential resources (e.g., nutrients, water, sunlight, food, atmosphere, or space), thus restricting or excluding the access a non-target organism has to such resources. Pests may also achieve negative effects in non-target organisms by causing or carrying a disease (e.g., acting as a disease vector).

The term “population” includes a plurality of individual organisms, the plurality comprising one or more kinds of organism. The term “pest population” includes a population of pest organisms and is used interchangeably herein with the terms “infection,” “colony,” or “infestation” of pest organisms. The pests may be non-arthropods.

Preferred examples of pest organisms include those eukaryotic organisms belonging to Kingdom Protista and Kingdom Monera of the Linnaean classification system, e.g, protists. Such preferred pest organisms may be either protists or prokaryotes which live out of aqueous environments (e.g., terrestrial protists), or those which live in aqueous environments (e.g., aquatic protists). Preferred examples of protist and monera pest organisms are algae, including, for example, filamentous algae, mat-forming green algae, single-cell blue-green algae, planktonic algae, freshwater blue green algae (e.g., Microcystis, Anabaena, Aphanizomenon, Schizathrix, and Trichodesmium). Other preferred examples of protist and monera pest organisms include Cyanophyceae, Chlorophyceae, Diatomaceae, protozoa, species in the Division Oomycota (e.g, water molds and downy mildews), Phytophthora infestans, Plasmopara viticola, and species of the genera Saprolegnia, Oscillatoria, Phormidium, Lyngbya, Nostoc, Coccomyxa, Cosmarium, Cylindrocystis, Kiebsormidium, Mesoaenium and Zygogonium, and the blue-green algae.

Other preferred pest organisms include non-protist organisms which are protist-like, e.g., hornwort, liverwort, and mosses.

The term “non-target organism” refers to organisms (e.g., plants or non-plants) which are not pest organisms and which are not targeted (e.g., not significantly controlled) by the methods described in this invention. Examples of non-target organisms are agricultural plants (e.g., plants of economic, horticultural, or ornamental importance) and animals (e.g., livestock, pets).

As used herein, the terms “control” and “controlling” include the ability to significantly modulate or significantly inhibit the growth or proliferation or colony formation of an organism or an organism population (e.g., modulating reproduction of an organism; causing destruction, increased mortality, or increased morbidity. of an organism). This can be measured using art-recognized techniques.

As used herein, the term “pesticidally effective amount” refers to the amount of a composition which is necessary to control a pest or a pest population using the methods of the invention. As further used herein, the term “pesticidally effective amount” may be described as a concentration (e.g. molarity, weight/volume percentage), and efficacy value (e.g., LD₅₀ values for a particular composition on a particular organism), a volume per organism (e.g a gas or vapor of a composition), a mass per organism (e.g., grams per kilogram). In another embodiment, a pesticidally effective amount of a composition may be an amount which controls at least 25%, preferably at least 50%, more preferably at least 70% or more of pests treated with the methods of the invention. In another preferred embodiment, a pesticidally effective amount includes an amount which controls a pest or pest population and, simultaneously, which does not control a non-target organism which exists incident to (e.g., in proximity to) the pest or pest population. It is to be understood that a pesticidally effective amount may vary depending on the intended use. For example, it may vary based on the type of pest organism, conditions of the environment and/or climate, type of non-target organism, etc.

As used herein, the terms “LD₅₀” and “lethal dose₅₀”, which are art-recognized terms, refer to the amount of a substance which, upon exposure (excluding inhalation) to a particular test population of organisms (e.g., plants, animals, protists), causes death in 50% of that population of organisms. LD₅₀ is usually expressed as milligrams or grams of material per kilogram of organism weight (mg/kg or g/kg).

A discrete amount of a composition of the invention which acts as a pesticidally effective amount may be determined empirically by routine procedures such as those exemplified herein, or those known to one skilled in the art. It is to be understood that a particular composition of the invention which causes a relatively higher level of control of pest organisms may be used in smaller amounts or concentrations (e.g., the composition requires lower pesticidally effective amounts). Conversely, a particular composition of the invention which causes a relatively lower level of control of pest organisms may be used in higher amounts or concentrations (e.g., the composition requires higher pesticidally effective amounts). It is further understood that compositions of the invention may be assayed to determine the extent of control they cause (e.g., phytotoxicity, damage) to a non-target organism that is colonized with a pest population or incident to (e.g., co-exists with) a pest population. In a preferred embodiment, a composition of the invention will control a pest colony while not controlling a non-target organism (e.g., a host organism, humans, wildlife, agricultural organisms).

The present invention is further based, at least in part, on methods controlling a pest population with a composition which involves contacting the pest population with a pesticidally effective amount of a benzyl ester compound and which also contains one or more compounds chosen from the group consisting of stabilizer, solvent, surfactant, active compound, and carrier.

As used herein, the term “stabilizer” includes antioxidant compounds which can inhibit or hinder reactions which can alter the integrity of the composition (e.g., oxidative reactions). The supplementing of compositions of the invention with stabilizers which are antioxidants can increase the shelf life of the composition, inhibit breakdown of the composition, or improve the efficacy of the composition after being applied to areas where pest control is desired. Preferred antioxidant stabilizers of the invention, include, but are not limited to, ascorbyl palmitate, anoxomer, benzoic acid, benzylkonium chloride, benzethonium chloride, benzyl alcohol, butylated hydroxyanisole (BHA), butylated hydroxytoluene (BHT), chlorobutanol, dehydroacetic acid, ethylenediamine, ferulic acid, potassium benzoate, potassium metabisulfite, potassium sorbate, n-propyl gallate BP, propylparaben, sassafras oil, sodium benzoate, sodium bisulfite, sodium metabisulfite, sorbic acid, vitamin B, eugenol, α-tocopherol, and the like. In a particularly preferred embodiment, an antioxidant stabilizer of the invention is one or more compounds chosen from the list consisting of: sodium benzoate, vitamin E, α-tocopherol, BHA, and BHT.

Antioxidant stabilizers of the invention may comprise 0.02-10% w/w of compositions of the invention. In a preferred embodiment, a preferred amount of an antioxidant stabilizer to use is determined empirically by a shelf-life stability trial in accordance with an EPA standard protocol. Furthermore, a minimized amount of antioxidant stabilizers of the invention which will increase shelf life and/or maintain chemical stability and integrity is preferred.

As used herein, the term “solvent” includes liquid phase compounds in which a composition of the invention can be suspended without significantly altering the usefulness of the composition. In a preferred embodiment, a solvent of the invention may be biorational (e.g., is found routinely in nature), environmentally safe, non-phytotoxic (e.g., will not harm a non-target host that is a plant), non-toxic (e.g., will not harm a non-target that is an animal), and entails low cost. A solvent of the invention can be an aqueous solvent (e.g., comprising primarily water) or an organic solvent, (e.g., comprising primarily one or more organic compounds) such as ether, ketone, kerosene, or alcohol. In a preferred embodiment, a solvent of the invention is water.

As used herein, the term “surfactant” refers to compounds which are able to facilitate the suspension (e.g., miscibility, dispersibility) of compositions of the invention in a solvent of the invention. The term is further meant to include the various kinds of wetting agents, dispersing agents, suspending agents, and emulsifying agents that are generally known in the art. Examples of surfactants which may be used in compositions of the invention include anionic surfactants, cationic surfactants, and non-ionic surfactants can be used. Anionic surfactants include fatty-acid salts, higher alcohol sulfuric esters and alkylallylsulfonates. Cationic surfactants include aliphatic amino salts, quaternary ammonium salts and alkylpyridinium salts (individually or in combination). In a preferred embodiment, a surfactant of the invention is a non-ionic surfactant. Examples of preferred non-ionic surfactants include allinol, nonoxynol, octoxynol, oxycastrol, oxysorbin (for example, polyoxyethylated sorbitol fatty-acid esters (TWEEN®); thalestol, and polyethylene glycol octylphenol ether (TRITON®). Particularly preferred surfactants of the invention include TWEEN® 20 (polyoxyethylene sorbitan monolaurate), TWEEN® 40, TWEEN® 80, TRITON®SP 150, TRITON® SP 180 and TRITON® SP 190. Other particularly preferred surfactants of the invention include TWEEN® 80 and TRITON° SP 190.

Other preferred surfactants of the invention include the class of compounds known as saponins. Saponins include compounds which have a sapogenein portion and a sugar moiety. The sapogenein portion of saponins of the invention may comprise a steroid or a triterpene. The sugar portion of saponins of the invention include glucose, galactose pentose and methyl pentose. Saponins of the present invention are preferably of a sterol glycoside which is widely distributed in plants. Saponins are described in, for example, Budvari, ed., The Merck Index, 11^{th} ed. Merck & Co., Inc. Rahway, N.J., 1990, pp. 1328. and Hostettmann, and Marston, Saponins. Chemistry and Pharmacology of Natural Products, 1995, Cambridge University Press, incorporated herein by reference. Preferred saponins for use in the present invention are derived from Yucca, particularly Yucca schidigera or Yucca valida. Of the saponin surfactants, those which are nonionic are particularly preferred.

Other preferred surfactants of the invention which are well know in the art (e.g., have well-known industry names) include Albenate, Alfos, Allinate, Allinol, Diocusate, Dooxynol, Ligsolate, Nofenate, Nonfoster, Nonoxynol, Octoxynol, Oxycastol, Oxysorbic, Tall oil, and Thalestol.

The preferred amount of a surfactant which is included in compositions of the invention is about a minimum amount needed to permit compositions of the invention to be dissolved or emulsified to a useful extent in solvent of the invention. These amounts may be about be 0.5% to 10% wt/wt, more preferably 0.5% to 1% wt/wt.

Alternatively, emulsions containing high concentrations of the organic compound of interest can be prepared. The organic compound is mixed with an emulsifying agent such as saponin in an aqueous solvent, generally water, while maintaining a ratio of at least 50% by weight of the organic compound, less than 10% by weight of the emulsifying agent and the balance of solvent. The mixture is agitated, generally by mechanical mixing, until an emulsion has formed, at which time optionally additional organic compound can be added to the emulsion if it is desired to further increase the concentration of organic compound in the emulsion. Emulsions of 60%, 70%, 80% and up to 90% can be prepared in this way, depending upon the organic compound.

As used herein, the art-recognized term “emulsify” includes the act or process of facilitating a stable mixture or dispersion of otherwise immiscible compounds or liquids (e.g., an oily liquid and an aqueous liquid) through the use of an emulsifier or emulsifying compound. As further used herein, the art-recognized terms “emulsifier” and “emulsifying compound” include a compound or a mixture of compounds which comprises surface-active molecules and which can stabilize a mixture or dispersion of otherwise immiscible compounds or liquids (e.g., an emulsion). Generally emulsifiers act either by coating one or more of the components of the mixture to prevent coalescing and/or alter the surface tension at the interface of suspended droplets. The concentrated emulsions readily re-disperse upon dilution in water to working concentrations of interest. The shelf life of the concentrated emulsions, either at room temperature (about 25° C.) or at refrigerator temperature (about 4° C.) is at least 1 year, although separation of an emulsion, once stably formed, has not been observed.

As used herein, the terms “active compound” and “active component” include compounds and components which can increase the efficacy of the compositions of the invention. In a preferred embodiment, an active compound of the invention does not increase toxicity (e.g., control) of compositions of the invention to non-target organisms. In a particularly preferred embodiment, an active compound of the invention minimizes or decreases toxicity (e.g., control) of compositions of the invention to non-target organisms. In a preferred embodiment, an active compound of the invention does not decrease toxicity (e.g., control) of compositions of the invention to pest organisms. In a particularly preferred embodiment, an active compound of the invention maximizes, or increases by more than an additive amount, the toxicity (e.g., ability to control) of compositions of the invention to pest organisms (e.g., acts as a synergist). The use of active compounds in synergistic combination with other pest control compounds is exemplified in, for example, U.S. Pat. No. 5,639,794, which is incorporated herein by reference. In another particularly preferred embodiment, an active compound of the invention maximizes or increases toxicity (e.g., control) of compositions of the invention to pest organisms, such that a reduction of the amount compositions of the invention will be comprise a pesticidally effective amount.

The present invention is further based, at least in part, on methods of controlling a pest population which involves contacting the pest population with a pesticidally effective amount of a composition which comprises Formula (I):

A-L-E

wherein A is an aryl moiety, L is a linkage moiety, and E is a terminal moiety.

As used herein, aryl moiety “A” of Formula (I) includes aryl moieties which are substituted or unsubstituted (e.g., non-substituted). A substituted aryl A moieties include aryl moieties which comprise a hydroxyl, a halogen, a carboxylic, or a ester of a carboxylic moiety. As further used herein, aryl moiety A includes aryl moieties which comprise phenyl, benzyl or aralalkyl moieties.

As used herein, linkage moiety “L” of Formula (I) includes a linking group of the formula [—(C═O)—B—]wherein B may be oxygen, a covalent bond, or sulfur. As further used herein, component “B” of the linkage moiety may attach either to aryl moiety “A” or terminal moiety “E”.

As used herein, terminal moiety “B” of Formula (I) includes a moiety which is lower alkyl, alkyl, aryl, heteroaryl, carbocyclic, phenyl, or aralalkyl. An aralalkyl moiety of a terminal moiety “E” includes those which comprise a phenyl, a benzyl, or a phenethyl moiety.

The present invention is further based, at least in part, on methods of controlling a pest population which involves contacting the pest population with a pesticidally effective amount of a composition which comprises Formula (II) and/or (III):

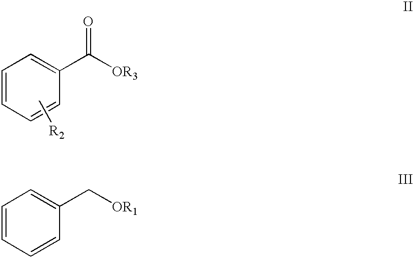

wherein R₁ is alkylcarbonyl; R₂ is H, OH, halogen, or alkyl; and R₃ is alkyl.

In preferred embodiments, R₁ is C ₁₋₅ alkylcarbonyl, R, is C₁₋₆ alkyl, alkoxy, R₃ is C₁₋₆ alkyl, aryl or arylalkyl. In a particularly preferred embodiment, R₁ is methyl carbonyl.

In particularly preferred embodiments, R₂ is C₁₋₆ alkoxy or [—COOR₄], wherein R₄ is alkyl, or, even more preferably, C₁₋₆ alkyl or H. Even more preferably, R₄ is [—(C═O)—O—(CH₂)₃CH₃]. In another particularly preferred embodiment, R₃ is aryl C₁₋₆ alkyl. In other preferred embodiments, R₃ is methyl, ethyl, benzyl, or phenyl.

As used herein, the term “alkyl” includes hydrocarbon moieties which contain 1 to 12 carbon atoms. The term alkyl further includes hydrocarbon moieties which are branched, unbranched, saturated, or substituted. Examples of alkyl groups include methyl, ethyl, propyl, isopropyl, tert-butyl, butyl, n-hexyl, and dodecyl. In a preferred embodiment, an alkyl group of the invention is a lower alkyl (branched or unbranched, saturated) having up to six carbon atoms (C₁₋₆) (e.g., methyl, ethyl, or tert-butyl).

For purposes of this invention, wherever the term “alkyl” is used, it should be understood that “alkenyl” or “alkynl” can be used as well. The alkenyl and alkynl moieties will also include 1-12 carbon atoms and can also be branched, unbranched, saturated, or substituted, as noted for the term “alkyl” above.

As used herein, the terms “alkoxy” and “alkoxy group” includes the group [—O-alkyl], wherein alkyl is defined above. In a preferred embodiment, the alkoxy group has up to four carbon atoms (C₁₋₄).

As used herein, the terms “arylalkyl” includes unsaturated cyclic carbon moieties which comprise a single aromatic ring (e.g., phenyl) and which may be linked to the molecule through an alkyl group. In a preferred embodiment, the alkyl group which links the aromatic ring of the arylalkyl group contains 1-6 carbon atoms (C₁₋₆) (e.g., a preferred arylalkyl group of the invention is “aryl C₁₋₆ alkyl”). In a particularly preferred embodiment, arylalkyl group is an aromatic ring (e.g., a phenyl) attached through a [—(CH₂)ₓ—] group (e.g., if x is 1, then this aralkyl moiety may be a benzyl moiety).

The terms “alkylcarbonyl” and “alkylcarbonyl group” includes alkyl groups which arc linked to the molecule through a carbonyl, (e.g., [—(CO)—]) group. Examples of alkylcarbonyl groups include methyl carbonyl and ethyl carbonyl. In a preferred embodiment, an alkylcarbonyl group of the invention is a C₁₋₅ alkylcarbonyl carbonyl group.

The term “aryl” includes 5- and 6-membered single-ring aromatic moieties that may include from zero to four heteroatoms (e.g., non-carbon atoms). Examples of such include, benzene, pyrrole, furan, thiophene, imidazole, oxazole, thiazole, triazole, pyrazole, pyridine, pyrazine, pyridazine and pyrimidine, and the like. Aryl groups also include polycyclic fused aromatic groups such as naphthyl, quinolyl, indolyl, and the like. Heteroatoms (e.g., non-carbon atoms) in the ring structure may also be referred to as “aryl heterocycles”, “heteroaryls” or “heteroaromatics”. Those aryl moieties having only carbon atoms in the ring structure may be referred to as carbocyclic aryl moieties. Aryl groups of the invention may be substituted at one or more ring positions with moieties, including halogen, alkyl, arylalkyl, alkenyl, alkynyl, cycloalkyl, hydroxyl, carbonyl, carboxyl, or the like.

As used herein, the term “halogen” is art-recognized and includes —F, —Cl, —Br and —I. The term “hydroxyl” means —OH. As further used herein, the art-recognized term “ester” designates an [—O—] linking moiety. As further used herein, the art-recognized term “carboxylic” includes [—COOH] and [—COO].

Exemplary preferred embodiments of compounds encompassed by Formula II include: methyl salicylate, ethyl salicylate, benzyl salicylate, benzyl benzoate, phenethyl salicylate, benzyl phthalate, and benzyl butyl phthalate having the chemical formulae:

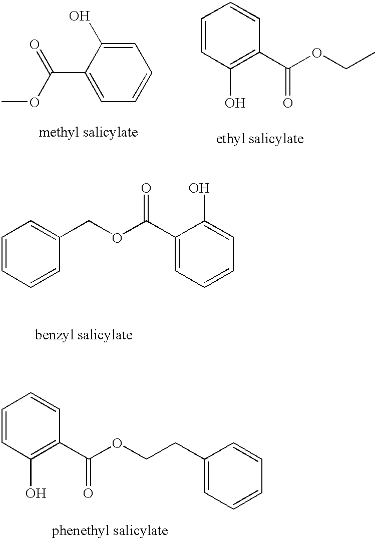

Exemplary preferred embodiments of compounds encompassed by Formula III include benzyl acetate, which has the chemical formula:

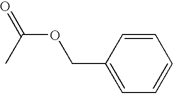

The compounds that are useful in the methods and compositions of the invention, as well as their properties, may be well known in the art. Compounds useful in the compositions of this invention are available from commercial sources known in the art, or can be readily synthesized by techniques as are well known in the art. For example, benzyl benzoate, benzyl salicylate and benzyl acetate can be obtained from B. F. Goodrich/Kalama Chemical Inc. (Kalama, Wash.) and Pentagon Chemical (Los Angeles, Calif.).

Benzy benzoate, (CAS Registration number 120-51-4), is widely used in the perfume and pharmaceutical industries. Its high molecular weight and nearly odorless nature make it a widely used perfume fixative. Benzyl benzoate has applications in products such as confectioneries and chewing gums and is produced commercially to meet the specifications described in the United States Pharmacopoeia (USP) and the Food Chemical Codes (FCC). Benzyl benzoate is found as a natural chemical in the volatile oil of the Myroxylon perierae Royle Klotzsch of the Family Leguminosae or Fabaceae (e.g. Peru Balsam oil). Benzyl benzoate also is found in the balsams of Tolu and Peru and in the oils of tuberose, ylang-ylang, and hyacinth. Benzyl benzoate can be synthesized via the Cannizarro reaction from benzyl chloride and sodium benzoate.

Benzyl salicylate, (CAS Registration number 118-58-1), is a natural product of Dianthus caryophyllus. Benzyl salicylate can be prepared by sodium salicylate and benzyl chloride (see, e.g., J. Am. Chem. Soc. (1921) 43:1672), and is readily available from commercial sources such as B. F. Goodrich/Kalama Chemical. Benzyl acetate occurs in a number of plants, particularly jasmine. Benzyl acetate can be prepared from benzyl chloride, acetic acid or sodium acetate and triethylamine (see, e.g., 11 Org. Chem. (1961) 26:5180). Benzyl phthalate can be prepared from disodium phthalate and benzyl chloride (U.S. Pat. No. 3,012,065). The LD₅₀ (rat) for benzyl benzoate, benzyl salicylate and benzyl acetate are 1,830; 2,227; and 2,490 mg/Kg, respectively, (Merck Index). These values are significantly higher than those of many currently used pesticides (e.g., these compounds are less harmful to non-target organisms than many currently used pesticides).

Referring to Formula (I), the preferred R² substituent is H, —OH or —COOR⁴, where R⁴ is Cl- 6 alkyl. R² is more preferable H, —OH or —COO—(CH₂)₃CH₃. The preferred R³ substituent is Cl-6alkyl, phenyl or arylCl-6alkyl such as benzyl. R³ is more preferably methyl, ethyl, benzyl or phenyl.

Preferred compounds of Formula (I) include methyl salicylate, ethyl salicylate, benzyl salicylate, benzyl benzoate, phenethyl salicylate, phenyl salicylate, benzyl phthalate and benzyl butyl phthalate. Even more preferred compounds of Formula (I) include methyl salicylate, ethyl salicylate, benzyl salicylate, benzyl benzoate, phenyl salicylate and benzyl butyl phthalate. Particularly preferred compounds of Formula (I) include ethyl salicylate, benzyl salicylate and benzyl benzoate.

Referring now to Formula (II), the preferred the preferred R¹ substituent is alkylcarbonyl, preferably C₁₋₅alkylcarbonyl, more preferably methylcarbonyl A particularly preferred compound of Formula (II) is benzyl acetate.

Emulsifiers or surfactants may be added to carboxy ester compositions to improve dissolution or suspension. These may be added to a spray apparatus or tank during mixing of the composition. For example, if the carboxy ester is benzyl benzoate, an emulsion may prepared, e.g., as described in Example 1, below, using TWEEN-20 as an emulsifier.

II. Practical Uses of the Invention

The preferred embodiments of the invention offer several advantages over currently used pest control agents and methods.

Firstly, the preferred compounds used in the composition of the invention are naturally-occurring compounds, and, as such, are expected to exhibit a high LD₅₀ in animals and hosts (e.g., non-target organisms) in comparison to LD₅₀ values for more dangerous pest control compounds. By using the preferred compositions, the environmental and health concerns involved in pest control are thus minimized. Furthermore, because of the reduced hazards of the preferred embodiments, the composition may be used as a preventative measure (e.g., prophylactically on a repeated basis) and, thus, may be integrated into Integrated Pest Management (IPM) programs. IPM programs arc generally sustainable approaches to managing pests by combining available biological, cultural, physical and chemical tools in ways designed to minimize economic, health and environmental risks. The preferred carboxy ester compounds of the invention described herein may be considered to be biorational chemicals (also referred to in the art as biopesticides) which qualify for the US EPA Biorational Program. Information regarding such compounds can be found, for example, at http://www.epa.gov/pesticides/biopesticides.

Secondly, the preferred embodiments of the invention have not been used previously as methods of pest control. It is likely that existing pests and pest organisms have not yet acquired resistance to them. It is recognized in the art that novel pesticides often become less effective against a particular pest or pest population after several seasons, e.g., the pests or pest populations can become resistant. This is often attributable to the singular mode of action of a particular pest control agent which is able to affect one or only a few critical biological pathways (e.g., metabolic pathways) of the pest organism. The result is that resistant populations may arise, either gradually through the selective pressure of resistant individuals in a population, or in a punctuated fashion such as by a chance genetic mutation. Generally, the more specific that the targeted molecular mechanism of a pest is, the greater the likelihood for that pest to develop a tolerance or full resistance to the targeting agent. The availability of a novel pest control agent, such as the embodiments of the present invention, will circumvent this problem.

The pest control compositions may be solid (i.e., in a powdered, encapsulated, or microencapsulated form) or liquid, depending on the particular pest control needs and situation. If the composition is solid, suitable art-recognized carriers are known including the many agriculturally-useful powders that are generally used for this purpose. In a preferred embodiment, a composition of the invention is a non-aqueous liquid. In a more preferred embodiment, a composition of the invention is an aqueous liquid. Liquid embodiments of the invention may be in the form of a solution, a suspension, or an emulsion, depending on the properties of the final pest control composition as well as the particular pest control requirements of the situation.

Generally, a composition of an embodiment of this invention may be prepared as a concentrate for convenient storage and/or transportation as required. Compositions of the present may be adjusted accordingly for large scale (e.g. industrial) utility or for smaller scale (e.g., private) utility. A composition of the invention may require appropriate dilution as needed from a concentrate, or may be manufactured as a “ready-to-apply” composition. This may also be a solid. Such a solid storage form will generally comprise a carboxy ester compound and one or more surfactants, such that miscibility or suspendability of the composition in an appropriate solvent can be achieved as needed.

Preferred embodiments of the invention exhibit reduced phytotoxicity, or are nonphytotoxic, if susceptible non-target organisms (e.g., hosts) include plants. Preferred embodiments of the invention exhibit reduced dermal sensitivity, or dermal insensitivity, if susceptible non-target organisms (e.g., hosts; incident wildlife) include higher eukaryotes (e.g., vertebrates, humans). Preferred embodiments of the present invention include pest controlling carboxy ester compounds which are present in pest control compositions at pesticidally effective amounts. In general, the percentage (by weight; w/w) of carboxy ester compounds in the pest control compositions of the invention may be about 0.1% to 50%. Preferred embodiments of the invention comprise carboxy ester compounds in optimized pesticidally effective amounts. Such amounts may be empirically determined using appropriate assays on a pest-by-pest basis. Higher concentrations of carboxy ester compounds may be used in some embodiments for purposes of manufacture, shipment, and storage. For example, a concentrated pest control composition of the invention which is used by professional agronomists can contain 10%-90% or more carboxy ester compound. Prior to use, the high concentration composition is diluted in a solvent to an appropriate concentration for the intended use of the composition. When fully diluted for consumer use as a “ready-to-apply” composition, the composition will typically be about 0.1% to 10% (w/v) of carboxy ester compound, more preferably 0.1 to 1% (w/v) of carboxy ester compound.

Pest control compositions of the invention may be prepared by mixing together the requisite amount of at least one carboxy ester compound, at least one carrier (e.g., one which is known in the art and is used routinely for agricultural methods), one or more surfactants, in an appropriate solvent. Other components (e.g., saponins, antioxidants, etc) may also be included as required prior to mixing.

The use of carrier components in the pest control compositions of the invention may be used to encapsulate or microencapsulate the compositions. Microencapsulation is an art recognized term and is a routine approach augmenting many useful agricultural agents with a carrier. Examples of encapsulation and microencapsulation of agriculturally useful agents are described in, Trimnell et al (1988) Entrapment of herbicides in Starch for Spray Applications J. Contr. Release 7:263-268, Shasha et al (1984) Starch-Borate Complexesfor EPTC Encapsulation, J. Appl. Polym. Sci. 29:67-73, Koestler (1980) Microencapsulation by Interfacial Polymerization Techniques—Agricultural Applications, In: Controlled Release Technologies: Methods, Theory, and Applications pp. 117-132, Kydonieus (ed.) CRC Press, Boca Raton, which are incorporated herein by reference. Water-dispersible powders, capsules, or pellet compositions of the invention are within the scope of the invention. Such solid compositions will generally contain, for example, a pest control composition, an inert carrier, and one or more wetting and dispersing agents. Inert carriers include materials of mineral origin, e.g., natural clays, kaolinites, attapulgite clay, diatomaceous earth, synthetic magnesium silicate, synthetic minerals derived from silica, and the like. A water-dispersible powder of the invention may also comprise include fatty-acid esters and antioxidants.

A preferred pH of a pest control composition of the invention is between 6.0 and 8.0, more preferably, pH 6.5-7.5. Neutral compositions are preferred to lower the risk of harm caused by alkalinity.

Preferred methods of the invention include those which employ essentially only the pest control compositions described herein. Other preferred methods of the invention include those which employ the pest control compositions described herein in combination with (e.g., simultaneously or sequentially) herbicides, insecticides, fertilizers, and other agriculturally useful agents not described herein. For example, a field may be sprayed with a composition of this invention before, after, or simultaneously during treatment with fertilizers, herbicides, insecticides, and the like. This may be determined to provide significant advantage or utility over existing methods. Pest control compositions of this invention include those which are admixtures of carboxy ester compounds and other materials (e.g., fertilizers, herbicides, insecticides) in order to facilitate a treatment method involving a single application.

The exact preferred methods of the present invention for any application may depend on an assessment by one skilled in the art. Such an assessment may take into account such factors as knowledge about the particular pest organism, on host, the surrounding environment, the prevailing weather, the local water table and others. While methods of the present invention which comprise minimal or minimized amounts of carboxy esters may effect some measurable level of control on pests or a pest population, a desired level of control is often the elimination of the pest or pest population. It is understood that elimination of a pest or pest population may require corresponding higher levels of use of pest control compositions of the invention. One application of the composition comprising carboxy esters may be sufficient to achieve control of the pest population, but additional applications may also be applied. Preferably, an additional application will be applied 7 to 14 days after a prior application.

The pest control compositions of the invention, both solids and liquids, may be applied to pest infestations or pest populations by spraying. The methods and equipment needed for a given treatment may be determined by one skilled in the art. Furthermore, methods of the invention described herein may be used to treat pest infestations or populations in dry, moist, or aquatic systems (e.g., the pest-infested area is a flowing or a standing body of water). An aquatic system which is treated with methods of the present invention may be either fresh water or salt water. Furthermore, the pest control compositions of the invention may be applied directly onto a host (e.g., an agricultural crop, a turfgrass) or into an appropriate rhizosphere.

In another preferred embodiment of the invention, methods of pest control described herein involve treatment of a pest or pest population at a site remote from the point at which the pest control compositions are applied (e.g., a watershed, upstream of a river or stream infestation).

Other facets of applying the compositions of the invention which are within the scope of the invention include applying to the ground, applying from the air (e.g., crop dusting), chemigation, application to the surface of crops, incorporation into the soil, application prior to planting (e.g., preplant), application prior to crop emergence (e.g., preemergent application), application after crop emergence (e.g., postemergent), application by brushing or dipping, and the like. It is understood that conditions of application may depend on multiple factors known to those of skill in the art.

In a particularly preferred embodiment of the invention, methods of the invention are used to control pests (e.g., algal) infestations on turf grass plants. In a similarly preferred embodiment methods of the invention are used to control protist-like organisms such as moss and blue-green algae.

The use of pesticides is regulated in the United States by the Environmental Protection agency (EPA) under authority of the Federal Insecticide, Fungicide and Rodenticide Act (FIFRA). Tolerance for residues of pesticides in agricultural commodities are established by the (EPA) and enforced by the Food and Drug Administration (FDA) under authority of the Federal Food, Drug and Cosmetic Act (FD&C Act). This regulatory environment necessitates further aspect of the invention involving manufacture. In this aspect a carboxy ester composition (e.g., a pest control composition of the invention) as defined herein, is combined with an agriculturally-acceptable carrier and stored in a suitable container. It is understood the container will be suitable for storing the composition for at least the length of the shelf life of its contents. Printed instructions describing proper or recommended methods of application (e.g., application method, recommended rate of application, dilution requirements, precautions, and the like) and/or a printed label indicating the specifications (e.g., flammability, chemical content, and the like) are also within the scope of the invention. Instructions of the invention will indicate the type of pest or pests for which the pest control composition of the invention is intended. The invention described herein may further include an application device (e.g., spray apparatus. nozzle, sifting perforations, and the like) in association with, or integrated with, the container of the invention. A container of the invention may be a container which does not react with, or significantly diminish, the pest control activity of the intended contents For example, a container may be constructed of polymer, glass, metal, and the like.

Embodiments of this invention are further illustrated by the following examples which should not be construed as limiting.

### EXAMPLES

### Example 1

Preparation of 10% (w/v) Benzyl Benzoate

A 10% (w/v) preparation of benzyl benzoate can be produced by first placing 100 grams of liquid benzyl benzoate in a 1 liter flask. Ten grams of TWEEN-20 is added to the benzyl benzoate. Heated water (65° C.) is gradually added with constant agitation until the total volume is 1 liter. Mixture is then agitated further with a magnetic stir bar at (˜medium setting) for at least 15 minutes or until a milky emulsion is formed. The 10% benzyl benzoate mixture is then allowed to cool.

### Example 2

Well-Plate Assay of Algicidal Activity

Methods for determining in vitro activity of the pesticidal composition against terrestrial algal species were adapted from a well-plate assay which is understood in the art and which was developed by Phillip Colbaugh, Department of Plant Pathology, Texas A&M University, Dallas, Tex.

A test formulation containing 10% benzyl benzoate, 1% TWEEN surfactant and 89% water was prepared as described in Example 1. Liquid cultures of Phormidiumalgae were homogenized into individual cells in a standard laboratory blender apparatus. One hundred fifty μl of the homogenized algal suspension were added to the wells of 96-well assay plates using multitip-transfer pipettes. To each well, 150 μl of various dilutions of the test formulation were added, such that final concentrations of bcnzyl benzoate in the test wells were 0.8%, 0.3%, and 0.1%. The plates were allowed to incubation under fluorescent light for 24 hours.

| Concentration of | | |
|---|---|---|
| Benzyl Benzoatc | | |
| (%) | Lethality | Comments |
| 0.8 | yes | Superior to Daconil |
| 0.3 | yes | Superior to Daconil |
| 0.1 | no | Same efficacy as |
| | | Daconil |
| Formula Blank | no | No efficacy |
| Control | | |
| (TWEEN-20) | | |

### Example 3

Filter Paper Assay of Algicidal Activity

Further methods for determining in vivo activity of the pesticidal composition against specific algal species were adapted from a filter-paper assay which is understood in the art and which was developed by Phillip Colbaugh, Department of Plant Pathology, Texas A&M University, Dallas, Tex. Briefly, the filter paper assay is designed to approximate an environment such as that found on a golf course, where algal pests can be particularly damaging. Blended fragment suspensions of Phormidium algae were passed through a coarse Whatman filter paper circle to collect the algal cells. The filter paper was then placed in a large Petri dish containing moist sand. The desired concentration of 10% benzyl benzoate formulation (0.8, 0.3 and 0.1% (w/v) final concentration) was placed on marked areas of the algae field to determine toxic effects. Observations were made 4 days after the test was initiated and were compared to control experiments using the known pesticide Daconil. Observations were considered in light of the fact that Daconil is frequently takes 3-4 rounds of application before it is effective against algae. It was determined that the formulation used in this study was very effective in killing Phormidiumat concentrations of 0.3% (w/v) and 0.8% (w/v) benzyl benzoate. The results of the observations are set forth below.

| Concentration of | |
|---|---|
| Benzyl Benzoate | |
| (%) | Zone of Inhibition |
| 0.8 | yes |
| 0.3 | yes |
| 0.1 | no |
| positive control | yes |
| (Daconil) | |
| Formula Blank | no |
| Control | |
| (TWEEN-20) | |

### Example 4

Phytotoxic Field Testing of Pest Control Compositions

A test formulation containing 10% benzyl benzoate, 1% TWEEN surfactant and 89% water was prepared as described in the previous Examples. This formulation was applied to two grass species, Tiffway hybrid bermudagrass and SR1020 bentgrass. One square foot test surfaces of each grass type were used. The test formulation was applied to test surfaces in dilutions corresponding to 0.8, 0.3, and 0.1% (w/v) benzyl benzoate. Only small signs of phytotoxicity were observed at the highest benzyl benzoate concentration. This phytotoxicity was determined to be not extensive enough to cause preclude the algicidal use of this formulation.

### Example 5

Spray Application of Carboxy Ester-containing Pest Control Compositions to Control Algal Pest Which Infest Turf grass.

A solution or emulsion of a carboxy ester may prepared at about 5-20% or another concentration which is convenient for storage and/or handling. For spray application, a tractor-transported spray apparatus and tank may be used. The 100 liter tank of a spray apparatus may be filled first with about 25 liters of water. The solution or emulsion of carboxy ester may then be added to the tank gradually and under constant agitation or stirring. An volume of the carboxy ester solution or emulsion may be added such that the final concentration in a 100 liter dilution will be 1%. If the emulsion of benzyl benzoate of Example 1 is used, ten liters are added. The rest of the tank is then filled with water under further agitation or stirring.

Properly calibrated spray equipment may then used to apply the carboxy ester agent to the surface of turfgrass. Agitation or mixing may be continually applied to the tank during application to maintain an even suspension or emulsion. Normally, 5-15 liters of agent may be used for 1000 square feet of turfgrass. An optimal amount may be determined empirically prior to use on representative and controlled test areas of the turfgrass. The turfgrass should be checked daily to verify effectiveness of the treatment. Adjustments to the frequency or amount of application may be made according to observations, or to other factors, such as changes in the weather which favor pest growth.

Field tests were conducted with 10% (w/v) benzyl benzoate, 1% Tween surfactant and 89% water, diluted to final concentrations of 0.8, 0.3 and 0.1% (w/v) benzyl benzoate prior to application. Each of the three concentrations and negative controls without benzyl benzoate were applied to one square foot of SRI 020 bentgrass or Tiffway hybrid bermudagrass, which was naturally infected with Phormidiumalgae, with a single spray application. The turfgrass was examined empirically for control of the algae as well and toxicity to the grass. Over the several days following the applications, the 0.8% benzyl benzoate formulation exhibited the most effective algae control, although the 0.3% formulation also demonstrated a significant level of control. At all of the concentrations tested, including 0.8%, little or no chemical “burn” was produced, thus demonstrating minimal phytotoxic effect on the two grass species tested.

### Example 6

Control of Moss with Different Formulations

A test of the effectiveness of three different formulations against moss was conducted on the north-facing wall of one greenhouse and the adjacent ground between two greenhouses. Replications approximately 0.5 m wide were laid out, one on the wall and one on the ground. The strips were separated by at least 2 m to ensure that there was no cross contamination. All the strips were heavily infested with active moss growth.

Three different chemicals, α-hexyl cinnamic aldehyde (HCA), benzyl benzoate (B2) and benzyl salicylate (BS) were each applied at 5% (w/v) concentration and sprayed to run-off. There was only one treatment application per strip. The formula emulsions consisted of the chemicals, a 1% Tween 20 surfactant, and water. A no treatment (negative control) was also evaluated. All sprays were applied using hand-held sprayers. Visual evaluations of phytotoxicity were taken at 24 and 48 hours, and again at one and two weeks.

Within 24 hours, each of the three formulations had caused the moss to turn to yellow or brown. The moss remained attached to the wall/ground, but easily flaked off. The control showed no visible degradation. This demonstrated that HCA, BS and B2 are all phytotoxic to moss at the tested concentrations.

Subsequent evaluations after 48 hours, 72 hours, 1 week and 2 weeks showed no regrowth of the moss where the formulations were applied. The moss of the negative control strip continued to thrive.

The above results demonstrate that a benzyl benzoate composition is effective in controlling pest populations, such as algae in turfgrass, without phytotoxic side effects, and that a single application is effective in killing moss without regrowth over the time period evaluated, namely two weeks, demonstrating a potential residual effect and long-term control.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

The invention now having been fully described, it will be apparent to one of ordinary skill in the art that many changes and modifications can be made thereto without departing from the spirit or scope of the appended claims.

What is claimed is:

1. A method of controlling a non-arthropod pest population, said method comprising:
contacting said non-arthropod pest population with a composition which comprises a pesticidally effective amount of a benzyl ester compound, wherein said non-arthropod pest population is selected from the group consisting of protists, protist-like organisms, monera, and combinations thereof.

2. The method according to claim 1, wherein said composition further comprises one or more compounds selected from the group consisting of a stabilizer, a surfactant, an active compound, a carrier, an emulsifier, and combinations thereof

3. The method according to claim 1, wherein said protists are algae.

4. The method according to claim 1, wherein said protist-like organisms are selected from the group consisting of hornwort, liverwort, mosses, and combinations thereof

5. The method according to claim 1, wherein said monera are blue-green algae.

6. The method according to claim 1, wherein said composition has little or no toxicity to non-targeted organisms.

7. A method for controlling a non-arthropod pest population, said method comprising contacting said non-arthropod pest population with a pesticidally effective amount of a composition comprising compound of Formula (II) 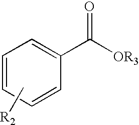
wherein
R₂ is H, OH, halogen, alkyl, alkoxy or —COOR₄;
wherein R₄ is alkyl or H;
R₃ is alkyl, aryl or arylalkyl; and
said non-arthropod pest population is selected from the group consisting of protists, protist-like organisms, monera, and combinations thereof.

8. The method according to claim 7, wherein R₂ contains 1 to 6 carbon atoms.

9. The method according to claim 7, wherein R₂ is —COOR.₄, and wherein R₄ contains 1 to 6 carbon atoms.

10. The method according to claim 7, wherein R₃ is C₁₋₆ alkyl, aryl C₁₋₆ alkyl, phenyl, or benzyl.

11. The method according to claim 7, wherein said composition further comprises one or more compounds chosen from the group consisting of a stabilizer, a solvent, a surfactant, an active compound, a carrier, an emulsifier, and combinations thereof.

12. The composition according to claim 11, wherein said surfactant or said emulsifier comprises one or more polyoxyethylated sorbitol fatty-acid esters, a saponin, or combination thereof

13. The method according to claim 7, wherein said composition has little or no toxicity to non-targeted organisms.

14. A composition comprising:
an benzyl ester compound in an amount sufficient to control a non-arthropod pest population, wherein:
said non-arthropod pest population is selected from the group consisting of protists, protist-like organisms, water molds, algae, cyanobacteria, moss, liverwort, hornwort, and combinations thereof; wherein
said compound is selected from the group consisting of methyl salicylate, ethyl salicylate, benzyl salicylate, benzyl benzoate, phenethyl salicylate, phenyl salicylate. benzyl phthalate, benzyl butyl phthalate, benzyl acetate, and a combination of any or all of said compounds.

15. The composition according to claim 14, wherein said composition is applied to non-target organisms selected from the group consisting of agricultural plants, livestock and pets.

16. The composition according to claim 15, wherein said non-target organisms comprise turfgrasses.

17. The composition according to claim 14, wherein said non-arthropod pest population comprises one or more mosses and said composition comprises benzyl benzoate, benzyl salicylate, or a combination thereof.

18. The composition according to claim 14, wherein said composition is applied to a surface comprising said non-arthropod pest population.

19. The composition according to claim 14, wherein said composition further comprises water and one or more compounds selected from the group consisting of a stabilizer, a surfactant, an active compound, an emulsifier, and a carrier.

20. The composition according to claim 14, wherein said amount sufficient to control is a concentration between about 0.1% to about 1.0% (w/v).

21. The composition according to claim 20, wherein said amount sufficient to control is a concentration of about 0.3% (w/v).

22. The composition according to claim 20, wherein said amount sufficient to control is a concentration of about 0.8% (w/v).

23. A method for reducing an algae population in turfgrass, said method comprising:
contacting said turfgrass with a composition comprising benzyl benzoate at a concentration of between about 0.1% to about 0.8% (w/v), an emulsifier, and water, wherein said composition has little or no toxicity to said turfgrass.

24. The method according to claim 23, wherein said emulsifier is one or more of polyoxyethylated sorbitol fatty-acid esters or a saponin.

25. The method according to claim 23, wherein said turfgrass is bermudagrass or bentgrass.

26. The method according to claim 23, wherein said algae is Phormidium.

27. A method for reducing a moss population on a surface, said method comprising:
contacting said moss with a composition comprising benzyl benzoate at a concentration of between about 0.1% and 10% (w/v), an emulsifier, and water.

28. The method according to claim 27, wherein said concentration is about 5% (w/v).
